(19) United States
(12) Patent Application Publication
(10) Pub. No.: US 2025/0383027 A1
(43) Pub. Date: Dec. 18, 2025

(54) Valve Apparatus, In Particular for a Housing of an Electronic and/or Electrical Device, as well as a Method for Production Thereof

(71) Applicant: Illinois Tool Works Inc., Glenview, IL (US)

(72) Inventors: Melanie Sindel, Nürnberg (DE); Jan Müller, Würzburg (DE)

(21) Appl. No.: 19/236,501

(22) Filed: Jun. 12, 2025

(30) Foreign Application Priority Data
Jun. 14, 2024 (DE) 10 2024 116 809.9
Jun. 10, 2025 (DE) 10 2025 122 683.0

(51) Int. Cl. F16K 17/19; H01M 50/317

(52) U.S. Cl. CPC F16K 17/19; H01M 50/317

(57) ABSTRACT

The disclosure describes a valve apparatus designed for use with the housing of an electronic or electrical device. This apparatus includes a housing with a connection section for attaching to another component and a surrounding section. A gas passage runs through the housing from the connection section to the surrounding section, in the opposite direction of assembly, to allow for pressure equalization or to relieve excess pressure. The gas passage is covered by a lid that sits roughly perpendicular to the assembly direction and includes at least one gas opening, also oriented perpendicularly. Inside the gas passage, a membrane is installed to help manage pressure changes or reduce positive pressure within the device.

### RELATED APPLICATIONS

The present application claims the benefit of German Patent Application No. 10 2024 116 809.9, filed Jun. 14, 2024, and German Patent Application No. 10 2025 122 683.0, filed Jun. 10, 2025, the contents of which are hereby incorporated by reference.

### BACKGROUND

When driving vehicles, for example electric vehicles, pressure differences in components occur in particular during uphill or downhill travel, during the entrance or exit from tunnels, during air freight transport, or in case of temperature differences. For example, pressure balance valves are provided in battery housings of electric vehicles, which ensure a continuous pressure balance of air via a membrane, but form a corresponding barrier to water or moisture.

Such pressure compensation valves are predominantly used in any closed housing, such as for lights, small electric motors (windscreen wipers, window regulators), EV peripherals (DC/DC converter, electric motor, transmission . . . ), and also in high-volt batteries of electric vehicles. In addition, for high-volt batteries, degassing and/or burst valves are often required, which, in the event of a thermal run-through of the battery cells, can release or deplete the corresponding positive pressure.

Such pressure compensation valves or burst valves or also combinations thereof generally have caps or covers that are clipped or welded to the housing in order to protect a membrane, in particular a pressure compensation membrane, against external influences, in particular against mechanical impacts.

Such a pressure compensation valve is disclosed, for example, in patent application EP4066311A1. One embodiment of the pressure compensation system described therein comprises a cover element that serves to protect and cover a burstable membrane or foil element. The burstable membrane or film element is attached to the opening of the base body with a protective element, wherein the protective element serves as contact protection and/or as a safety device for the foil element. Preferably, the cover is pushed out or blown off by the pressure of the escaping gas. The pressure compensation system described in EP4066311A1 has a relatively complex design, not only to cause controlled bursting of the foil element supported by a protective element, but also to push out or blow off the cover if necessary.

### SUMMARY

The present disclosure relates generally to a valve apparatus, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a schematic, perspective view of a valve apparatus according to the disclosure according to a first exemplary embodiment.

FIG. 2 is a further schematic, perspective view of the valve apparatus according to the disclosure.

FIG. 3 is a schematic side view of the valve apparatus according to the disclosure.

FIG. 4 is a schematic view of the valve apparatus according to the disclosure from FIG. 3, cut along line A-A.

FIG. 5 is a further schematic, perspective view of the valve apparatus according to the disclosure.

FIG. 6 is a plan view from below or counter to the assembly direction onto a membrane of the valve apparatus.

FIG. 7 is a schematic, perspective view of the valve apparatus according to the disclosure according to a second exemplary embodiment.

FIG. 8 is a further schematic, perspective view of the valve apparatus.

FIG. 9 is a schematic side view of the valve apparatus.

FIG. 10 is a schematic side-cut view of the valve apparatus from FIG. 9, cut along the line B-B.

FIG. 11 is a schematic plan view of the valve apparatus from below.

### DETAILED DESCRIPTION OF THE DISCLOSURE

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a valve apparatus, in particular for a housing of an electronic and/or electrical device, as well as a method for producing it.

A problem addressed by the present disclosure is to provide a valve apparatus for housings, in particular for a housing of an electronic and/or electrical device, as well as a method for producing it that is simple and can be manufactured inexpensively.

A further problem addressed by the present disclosure is to form a valve apparatus as well as a corresponding method for its manufacture, which represent an alternative to valve apparatuses and methods known from the prior art.

A further problem addressed by the present disclosure is to provide a valve apparatus and a method for its production that are safe and reliable in operation.

According to the disclosure, a valve apparatus, in particular a pressure compensation valve, is provided. It comprises a housing device having a connection portion for connecting to a component and a surrounding portion, wherein the housing device comprises a gas passage opening extending from the connection portion to the surrounding portion counter to an assembly direction for pressure compensation and/or for reducing a positive pressure, and wherein the housing device comprises a cover for the gas passage opening, which preferably extends approximately orthogonally to the assembly direction and has at least one gas opening orthogonal to the assembly direction, and a membrane arranged in the gas passage opening for pressure compensation and/or for reducing a positive pressure.

According to the disclosure, it is thus provided that the cover is part of the housing-like valve body.

As described above, such valve apparatuses generally comprise caps and covers that are clipped onto or welded to a housing in order to protect a membrane against external influences, in particular against mechanical damage.

It has been recognized that such caps or covers require an additional part in the manufacturing process of such a valve apparatus. The membranes are, in most cases, welded onto the housing in the assembly direction or on the surrounding side, wherein a corresponding cover or cap is also applied to the housing in the assembly direction in order to protect the membrane.

This means firstly that a housing of such a valve apparatus must be produced. Subsequently, a membrane is then welded to the housing in the assembly direction. Then, it is necessary to protect the membrane against external influences by way of a cover, which is welded to the housing as well, or clipped onto the housing. This means additional effort and cost in the manufacturing process.

According to the disclosure, it is now provided that the membrane is welded to the housing device counter to the assembly direction, i.e., on the connection side or from the bottom, so that the additional part, namely the cover or the cap, can be spared. This results in lower manufacturing costs and significantly simplifies the design of such a valve apparatus.

According to the present disclosure, the cover is thus an integral part of the housing device or a housing-like valve body. In this way, it is possible to produce the cover and the valve body from plastic in a single manufacturing process or method, in particular by means of a single-component injection molding process.

It is then provided that the membrane is connected by way of welding to the housing-like valve body counter to the assembly direction or from below.

This results in yet another mechanical advantage due to the welding position and the arrangement of the membrane in a final assembly position or in the installed state, for example for battery housings for electric vehicles, because the membrane is supported during operation at higher air flows by a pressure impingement counter to the assembly direction or from the bottom.

According to the disclosure, it is thus provided that the cover can be integrally connected to the housing device and can thus be an integral part of the housing device.

Furthermore, the housing device can comprise a membrane receiving portion to which the membrane is connected, wherein the membrane is connected to the membrane receiving portion on the connection side and thus counter to the assembly direction.

In this way, the advantages described above can be achieved. It is thus possible to form the housing device together with the cover in a single manufacturing step, namely by means of a single-component injection molding process, and subsequently connect the membrane to the housing device in a simple manner counter to the assembly direction or from below.

The membrane receiving portion can be configured as a tangentially circumferential web or as an edge on an inner casing wall of the housing device, comprising a membrane receiving surface, wherein the membrane receiving surface faces in the assembly direction and thus towards the connection side or towards a corresponding component.

A connection of a connection portion of a membrane that faces counter to the assembly direction and thus towards the surrounding can be established with the membrane receiving surface of the membrane receiving portion by welding.

The at least one or more gas passage openings extend approximately orthogonally to the assembly direction between the cover and the housing device, so that gas can preferably escape from the valve apparatus orthogonally to the assembly direction and that the membrane resists corresponding pressure washer tests.

This means that the gas passage openings are arranged and configured such that, no matter from which angle the cover or the valve apparatus is exposed to water during operation or a water jet in a so-called pressure washer test, the latter is always deflected away by the gas opening, the housing device, or the cover such that it cannot directly or linearly impact the membrane.

In addition, a seal for sealing the valve apparatus against a component can be provided on an outer casing wall of the housing device in a tangentially circumferential manner.

Furthermore, it can also be provided that fastening means for connecting the valve apparatus to a component are arranged on an outer casing wall of the housing device.

The housing device can have a rectangular or round or oval or polygonal cross-section when viewed from above.

In addition, according to the present disclosure, a method for producing a valve apparatus as described above is provided. It comprises the following steps:
producing an integral unit consisting of a housing device and cover from plastic by means of a single-component injection molding process, and
applying a connection portion of a membrane, which faces counter to an assembly direction and thus towards the surrounding, onto a membrane receiving surface of a membrane receiving portion of the housing device, which faces in the assembly direction and thus towards a component or housing, by means of welding.

The advantages of the method according to the disclosure correspond analogously to the advantages described above based on the valve apparatus according to the disclosure.

Furthermore, it can be provided that the integral unit consisting of the housing device and cover and a seal molded on the housing device are produced from a hard component (housing device with integrally molded cover) by way of a two-component injection molding process.

In this way, the manufacture of such valve apparatuses is significantly simplified, because, due to the simplified design of the valve apparatus, a simplified manufacturing process or method is also possible.

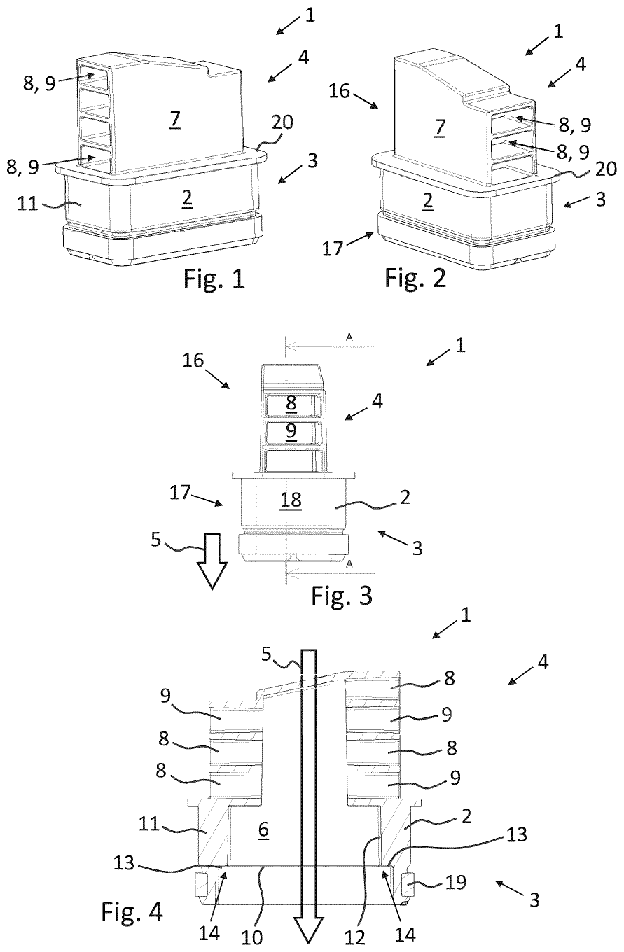

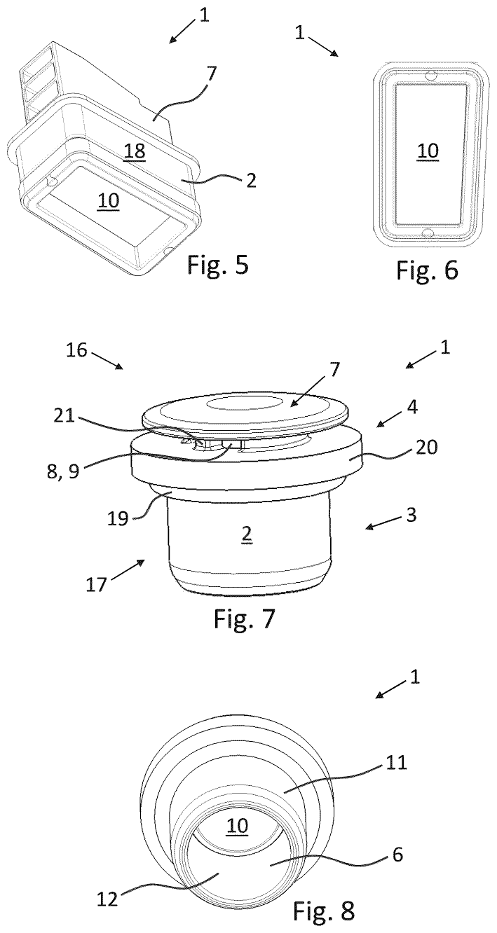

In the following, a valve apparatus 1 according to the disclosure, preferably a pressure balance valve with a bursting function, in particular for a housing of an electronic and/or electrical device, for example for a battery housing of an electric vehicle (not shown) or for any closed housing, for example, for lights, small electric engines (disc wipers, window regulators) EV peripheral (DC/DC converter, E-engines, transmission . . . ) or also high-volt batteries are described in more detail according to a first exemplary embodiment (FIGS. 1 to 6).

The valve apparatus 1 comprises a housing device 2 with a connection portion 3 for connecting to a component (not shown) and a surrounding portion 4.

The housing device 2 limits a gas passage opening extending from the connection portion 3 to the surrounding portion 4 counter to an assembly direction 5 or in an axial direction for pressure compensation and/or for reducing a positive pressure.

In the context of the present disclosure, the assembly direction 5 is understood to mean a direction that extends approximately orthogonally in relation to a component or a surface of a housing into which the valve apparatus is inserted. The assembly direction in the context of the present disclosure can also be referred to as an axial direction of the valve apparatus 1. The assembly direction is thus the direction in which the valve apparatus 1 is introduced into a component during assembly. Furthermore, the housing device 2 consists of the housing device 2 itself and an integrally connected cover 7.

The cover 7 extends approximately orthogonally to the assembly direction 5.

According to the first exemplary embodiment, the cover 7 is also configured in a housing-like manner and, according to the present exemplary embodiment, comprises gas openings 8 (three on one side three and four on the other side) extending orthogonally to the assembly direction 5 for the directed discharge of gas flows.

In other words, according to this exemplary embodiment, the gas openings 8 are configured as flow channels 9 that orthogonally discharge or supply air escaping from the valve apparatus 1 or also entering in the assembly direction 5 (i.e., sideways). This also prevents or at least minimizes potential flow turbulence within the gas passage opening 6, thereby optimizing gas flow and allowing the gas to escape as quickly as possible.

The flow channels 9 of the gas openings 8 thus form specially designed flow shafts, which, when the valve apparatuses are subjected to water or a corresponding pressure washer test, it is also prevented that a membrane 10 of the valve apparatus 1 is directly impacted by water. Water jets are discharged through the flow channels 9 accordingly, so that they cannot impact the membrane linearly or directly.

The housing device 2 is limited by a housing wall 11.

A rod-like membrane receiving portion 13 is molded on an inner casing wall 12 of the housing wall 11 in a tangentially circumferential manner and in a radially inward direction towards the gas passage opening 6.

The membrane receiving portion 13 thus forms a membrane receiving surface 14 facing in the assembly direction 5. The membrane receiving surface thus faces in the direction of a connection side 15 or in the assembly direction 5.

A tangentially circumferential lateral edge of the membrane 10 or the pressure compensation membrane faces counter to the assembly direction 5 or in the direction of a surrounding side 16 of the valve apparatus 1.

The membrane 10 can thus be inserted or mounted counter to the assembly direction 5 on the connection side into the housing device 2, wherein the connection portion 17 of the membrane 10, which faces counter to the assembly direction or towards the surrounding 16, is connected to the membrane receiving surface of the membrane receiving portion 13, which faces in the assembly direction 14, in particular by welding.

A seal 19 for sealing against a component, in particular a housing, is molded in a tangentially circumferential manner on an outer casing wall 18 of the housing device 2.

The seal 19 can be connected to the housing device 2 during the manufacturing process of the valve apparatus 1 by means of a two-component injection molding process.

Furthermore, the valve apparatus 1 on the outer casing wall 18 of the housing device 2 comprises connecting means, in particular a latch means (not shown), for connecting to a component or a housing.

The housing device 2 of the valve apparatus 1 according to the disclosure according to the first exemplary embodiment has an approximately rectangular-shaped cross section when viewed from above.

In the transition region of the housing device 2 to the cover 7, a retaining web 20 extending radially outwardly can be molded on in a tangentially circumferential manner in order to support the valve apparatus 1 on a component or housing in the assembly direction and thus define a mounting position in the assembly direction 5. The retaining web 20 thus forms a type of stop.

The connecting means then fix the valve apparatus accordingly in a component or a housing.

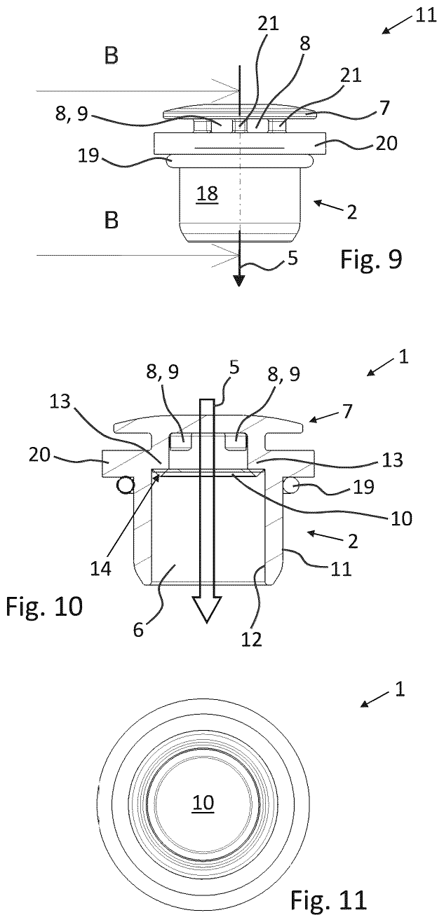

In the following, a valve apparatus 1 according to the disclosure is described in further detail according to a second exemplary embodiment (FIGS. 7 to 11).

Unless otherwise described, the valve apparatus 1 according to the second exemplary embodiment of the disclosure has the same technical features as the valve apparatus 1 according to the first exemplary embodiment. Identical technical features bear the same reference numerals.

By contrast to the valve apparatus 1 according to the first exemplary embodiment, the housing device 2 and the cover 7 of the valve apparatus 1 are configured as round or circular when viewed from above.

According to this exemplary embodiment, it is provided that the cover 7 is connected to the housing device 2 via webs 21 extending in the assembly direction 5.

The arrangement of the membrane 10 corresponds analogously to the arrangement of the membrane 10 according to the first exemplary embodiment.

According to the second exemplary embodiment, gas openings 8 are also provided, which extend outwardly in a radial direction orthogonal to the assembly direction.

The cover 7 correspondingly covers the webs 21, so that the membrane 10 cannot be directly or linearly exposed to water jets when subjected to water or a corresponding pressure washer test.

The water jets are deflected through the cover and/or the gas openings and/or the flow channels accordingly, so that, when water enters orthogonally to the assembly direction, it cannot impact the membrane through the gas openings 8 or flow channels 9 delimited by the cover 7, the housing device 2, and the webs 21. In the embodiment shown here (see, for example, FIG. 10), the integrally formed webs 21 extend directly from the step of the membrane receiving surface 14 of the membrane receiving section arranged on the inner jacket wall 12. This keeps the design of the valve apparatus and its manufacturing process particularly simple.

In addition, according to the present disclosure, a method for producing a valve apparatus as described above is provided.

It comprises the following steps of: producing an integral unit consisting of a housing device and cover from plastic by means of a single-component injection molding process, and applying a connection portion of a membrane, which faces counter to an assembly direction and thus towards the surrounding, onto a membrane receiving surface of a membrane receiving portion of the housing device, which faces in the assembly direction and thus towards a component or housing, by means of welding.

Furthermore, it is contemplated that the integral unit consisting of the housing device and cover and a seal molded on the housing device are produced from a hard component (housing device with integrally molded cover) by way of a two-component injection molding process.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE SYMBOLS

1 Valve apparatus
2 Housing device
3 Connection portion
4 Surrounding portion
Assembly direction
6 Gas passage opening
7 Cover
8 Gas opening
9 Flow channel
Membrane
11 Housing wall
12 Inner casing wall
13 Membrane receiving portion
14 Membrane receiving surface
Connecting side
16 Surrounding side
17 Connecting portion
18 Outer casing wall
19 Seal
Retaining web
21 Web

What is claimed is:

1. A valve apparatus (1) for a housing of an electronic or electrical device, the valve apparatus (1) comprising
a housing device (2) having a connection portion (3) for connecting to a component and a surrounding portion (4), wherein the housing device (2) comprises a gas passage opening (6) extending from the connection portion (3) to the surrounding portion (4) counter to an assembly direction (5) for pressure compensation or for reducing a positive pressure,
wherein the housing device (2) comprises a cover (7) for the gas passage opening (6), which extends approximately orthogonally to the assembly direction (5) and has at least one gas opening (8) orthogonal to the assembly direction (5); and
a membrane (10) arranged in the gas passage opening (6) for pressure compensation or for reducing a positive pressure.

2. The valve apparatus (1) according to claim 1, wherein the cover (7) is integrally connected to the housing device (2) and is thus an integral piece of the housing device (2).

3. The valve apparatus (1) according to claim 1, wherein the housing device (2) comprises a membrane receiving portion (13) to which the membrane (10) is connected, wherein the membrane (10) is connected to the membrane receiving portion (13) on the connection side and thus counter to the assembly direction (5).

4. The valve apparatus (1) according to claim 3, wherein the membrane receiving portion (13) is formed as an inner sheath wall of the housing device (2) and tangentially circumferential web (21) comprising a membrane receiving surface (14), wherein the membrane receiving surface (14) faces in the assembly direction (5) and thus towards a connection side (15).

5. The valve apparatus (1) according to claim 4, wherein a connection of a connection portion (3) of the membrane (10), which faces counter to the assembly direction (5) and thus towards the surrounding, to the membrane receiving surface (14) of the membrane receiving portion (13) is produced by welding.

6. The valve apparatus (1) according to claim 1, wherein the at least one or more gas passage openings (6) extend approximately orthogonally to the assembly direction (5) between the cover (7) and the housing device (2), so that gas can preferably escape from the valve apparatus (1) orthogonally to the assembly direction (5) and that the membrane (10) resists corresponding pressure washer tests.

7. The valve apparatus (1) according to claim 1, wherein a seal (19) is arranged on an outer casing wall of the housing device (2) for sealing the valve apparatus (1) against a component, in particular a battery housing, or fastening means are arranged on the outer casing wall of the housing device (2) for connecting the valve apparatus (1) to a component.

8. The valve apparatus (1) according to claim 1, wherein the housing device (2) has a rectangular or a round cross-section when viewed from above.

9. A method for producing a valve apparatus (1) according to claim 1, comprising the following steps:
producing an integral unit consisting of a housing device (2) and cover (7) by means of a single-component injection molding process; and
applying a connection portion (3) of a membrane (10), which faces counter to an assembly direction (5) and thus towards the surrounding, onto a membrane receiving surface (14) of a membrane receiving portion (13) of the housing device (2), which faces in the assembly direction (5), by means of welding.

10. The method according to claim 9, wherein the integral unit consisting of the housing device (2) and the cover (7) and a seal (19) molded onto the housing device (2) is produced by way of a two-component injection molding process.
